(19) United States
(12) Patent Application Publication
(10) Pub. No.: US 2013/0045903 A1
(43) Pub. Date: Feb. 21, 2013

(54) Process and Apparatus to Remove Oxidation Products from Used Oil

(71) Applicants: Robert O. Crowder, Lino Lakes, MN (US); John H. Burban, Lake Elmo, MN (US); Andrew J. Ohotto, Saint Louis Park, MN (US); Abbey M. Vados, Cedar, MN (US); Michael M. Dimovski, Elk River, MN (US); David S. Kolstad, White Bear Lake, MN (US)

(72) Inventors: Robert O. Crowder, Lino Lakes, MN (US); John H. Burban, Lake Elmo, MN (US); Andrew J. Ohotto, Saint Louis Park, MN (US); Abbey M. Vados, Cedar, MN (US); Michael M. Dimovski, Elk River, MN (US); David S. Kolstad, White Bear Lake, MN (US)

(21) Appl. No.: 13/586,768

(22) Filed: Aug. 15, 2012

Related U.S. Application Data
(60) Provisional application No. 61/523,719, filed on Aug. 15, 2011.

(51) Int. Cl. C10M 175/00; F01M 11/03; B01D 15/00

(52) U.S. Cl. 508/111; 210/194; 210/130; 210/137; 210/195.1

(57) ABSTRACT

An apparatus for removing contaminants from used lubricating or hydraulic oil includes a fluid transfer unit that includes an inlet port and an outlet port. The inlet port can be in fluid communication with a source of the used lubricating or hydraulic oil. The fluid transfer unit can define a fluid path. The apparatus can include a first adsorbent and a second adsorbent in the fluid path. The first adsorbent can include cellulose. The second adsorbent can include silica gel.

### CROSS REFERENCE TO RELATED APPLICATIONS

This application claims priority to U.S. Provisional Patent Application No. 61/523,719, filed Aug. 15, 2011, which is hereby incorporated by reference as if set forth in its entirety.

### BACKGROUND

The present invention relates generally to the regeneration of used hydraulic or lubricating oil. These oils are used a wide range of applications such as gas or steam turbines, engines, earth moving equipment, aircraft, and industrial machinery. Over time and use, these oils can develop oxidation byproducts and other polar contaminants that degrade the oil and equipment. Removing these products prolongs the useable life of the oil and reduces downtime and maintenance of the equipment.

When oil is used in equipment as a lubricant or as a hydraulic fluid, it is commonly exposed to conditions that cause deterioration. When oil is exposed to oxygen, which is difficult to avoid, it can undergo partial oxidation over time. The mechanism for this partial oxidation is not completely understood, but it is believed that the hydrocarbons that make up the oil form organic hydroperoxides and begin a free-radical chain reaction. Whatever the exact nature of these reactions, the resulting products include peroxides, ketones, alcohols, acids, esters, aldehydes, and many other oxygen containing chemical compounds. This process is naturally accelerated, as most chemical reactions are, by the addition of heat, which unfortunately is commonly found in machinery.

These oxygen containing functional groups can react together or with other hydrocarbons to form larger molecules. Due to their large size and the polar nature of the oxygen bonds, these molecules appear to be poorly soluble in the non-polar hydrocarbons making up the bulk of the oil. At elevated temperature these large molecules or polymers may remain in solution with the non-degraded oil, but when the velocity decreases or the temperature drops in portions of the circulation loop, they may film out as varnish on valves, orifices, or other sensitive components causing the equipment performance to degrade. In addition to varnish production, oxidation can be a source for viscosity changes, acid number increase, corrosion, additive depletion, and sludge formation.

When these products and associated issues become too severe, it is necessary to either replace the oil or find some way to regenerate it within the equipment. Replacement is obviously difficult and expensive, requires the equipment to be shut down, and generates a waste product.

Naturally, there has been work in the field to develop techniques, processes, and equipment for removing these degradation products from the oil so that it can either be reused, or even better, remain in use. One method for removing undesirable operational byproducts is to use adsorbents, either modified natural products or completely artificial ones. Some of these methods include the use of activated bauxite (U.S. Pat. No. 2,446,489), clay (U.S. Pat. No. 4,383,915), activated carbon (U.S. Pat. Nos. 4,977,871 and 4,502,948), silica gel or alumina (U.S. Pat. No. 4,502,948), immobilized substrate with dispersant function groups (U.S. Pat. Nos. 5,042,617 and 5,478,463), and anionic ion exchange resins (U.S. Pat. Nos. 5,661,117 and 6,358,895). These adsorbents can be combined with filtration (U.S. Pat. No. 6,138,722) and are sometimes combined with more exotic processes such as vacuum (U.S. Pat. Nos. 4,272,371 and 6,358,895) or membrane filtration (U.S. Pat. No. 6,024,880).

However, these methods and equipment have room for improvement in removing oxidation products from used oil.

### SUMMARY OF THE INVENTION

In one embodiment, the invention can provide an apparatus for removing contaminants from used lubricating or hydraulic oil. The apparatus can include a fluid transfer unit including an inlet port and an outlet port. The inlet port can be in fluid communication with a source of the used lubricating or hydraulic oil. The fluid transfer unit defines a fluid path. The apparatus can also include a first adsorbent in the fluid path. The first adsorbent can include cellulose. The apparatus can further include a second adsorbent in the fluid path. The second adsorbent can include silica gel.

In another form, the invention can provide for a method of removing contaminants from used lubricating or hydraulic oil. The method can include providing a source of used lubricating or hydraulic oil and providing an apparatus including a fluid transfer unit. The fluid transfer unit can include an inlet and an outlet and can be in fluid communication with the source of the used lubricating or hydraulic oil. The fluid transfer unit can define a fluid path. The method can also include providing a first adsorbent and a second adsorbent in the fluid path, the first adsorbent including cellulose, the second adsorbent including silica gel. Additionally, the method can include moving the used lubricating or hydraulic oil from the source of the used lubricating or hydraulic oil to the apparatus such that the fluid path of the used lubricating or hydraulic oil contacts the first adsorbent and the second adsorbent to remove contaminants from the used lubricating or hydraulic oil.

In another embodiment, the invention can provide for an apparatus for removing contaminants from used lubricating or hydraulic oil. The apparatus can include a fluid transfer unit including a first housing and a second housing. The first housing can define a first interior space and can include a first inlet port and a first outlet port. The second housing can define a second interior space and can include a second inlet port and a second outlet port. The fluid transfer unit can define a fluid path wherein the first housing is in fluid communication with the second housing. The apparatus can further include a first adsorbent in the fluid path, the first adsorbent including cellulose. The apparatus can also include a second adsorbent in the fluid path, the second adsorbent including silica gel.

These and other features, aspects, and advantages of the present invention will become better understood upon consideration of the following detailed description, drawings, and appended claims.

### BRIEF DESCRIPTION OF THE DRAWINGS

FIG. 1 is a schematic of an example embodiment of an apparatus for removing contaminants from used lubricating or hydraulic oil according to the invention.

FIG. 2A is a perspective view of one embodiment of an adsorption element for use in the cellulose canister of the apparatus of FIG. 1.

FIG. 2B is a top view of the adsorption element of FIG. 2A.

FIG. 2C is a cross-sectional view of the adsorption element of FIGS. 2A and 2B taken along line 2C-2C of FIG. 2B.

FIG. 3 is a perspective view of another embodiment of an adsorption element and cellulose canister for use in the apparatus of FIG. 1.

FIG. 3A is a cross-sectional view of the adsorption element and cellulose canister of FIG. 3 taken along line 3A-3A of FIG. 3.

FIG. 4 is a perspective view of the silica canister of the apparatus of FIG. 1.

FIG. 4A is a cross-sectional view of the silica canister of FIG. 4 taken along line 4A-4A of FIG. 4.

FIG. 5 is a schematic of a second example embodiment of an apparatus for removing contaminants from used lubricating or hydraulic oil according to the invention.

FIG. 6A is a perspective view of one embodiment of a cellulose canister for use in the apparatus of FIG. 5.

FIG. 6B is a perspective view of one embodiment of an adsorption element for use in the cellulose canister of FIG. 6A.

FIG. 6C is a top view of the cellulose canister of FIG. 6A.

FIG. 6D is a cross-sectional view of the cellulose canister of FIGS. 6A and 6C, with the adsorption element of FIG. 6B inserted into the cellulose canister, taken along line 6D-6D of FIG. 6C.

FIG. 7A is a perspective view of one embodiment of a silica canister for use in the apparatus of FIG. 5.

FIG. 7B is a perspective view of one embodiment of a silica adsorption element for use in the silica canister of FIG. 7A.

FIG. 7C is a top view of the silica canister of FIG. 7A.

FIG. 7D is a cross-sectional view of the silica canister of FIGS. 7A and 7C, with the silica adsorption element of FIG. 7B inserted into the silica canister, taken along line 7D-7D of FIG. 7B.

### DETAILED DESCRIPTION OF THE PREFERRED EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

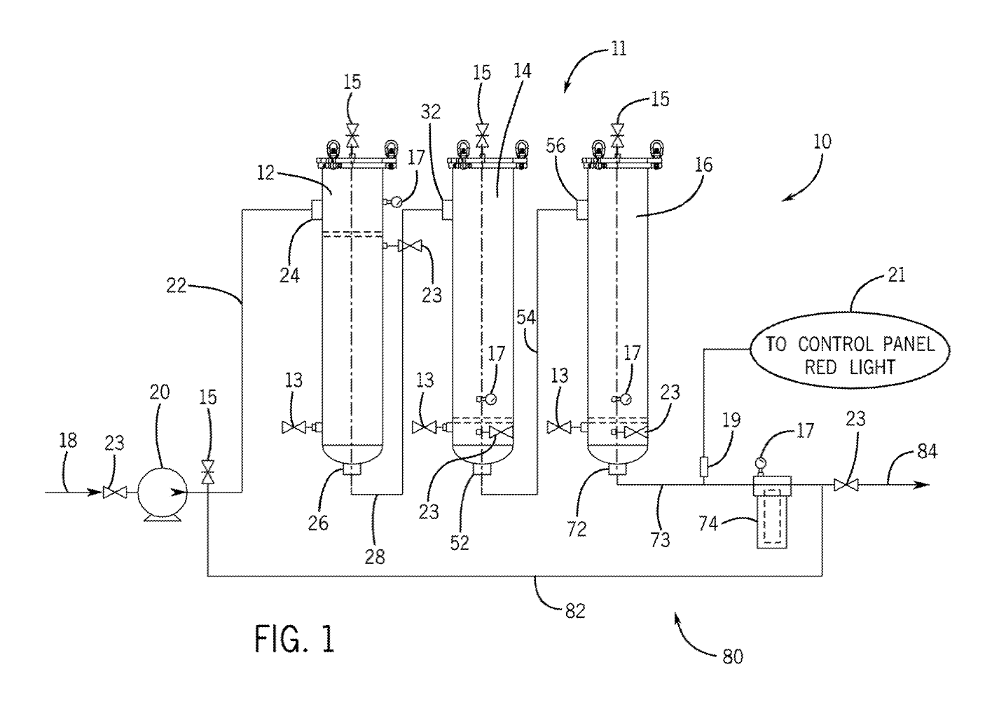

Referring to FIG. 1, there is shown an example embodiment of an apparatus 10 for removing contaminants from used lubricating or hydraulic oil. The apparatus 10 includes a fluid transfer unit 11. The apparatus 10 includes a fine filtration canister 12, a cellulose canister 14, and a silica canister 16. Used lubricating or hydraulic oil is fed from a source (not shown) of used lubricating or hydraulic oil through an oil inlet 18 and valve 23 by way of a gear pump 20. In one embodiment, the gear pump 20 can provide a flow rate of sixteen gallons per minute of flow through the apparatus 10 and can be connected to a control panel 21. The gear pump 20 moves the used lubricating or hydraulic oil through a hose conduit 22 to an inlet port 24 of the fine filtration canister 12 which includes filter media providing fine filtration. The filtration canister 12 can include a microfiber filter media having a pore size of 1 micron, such as used in Porous Media's GENESIS® coreless filter elements. The hose conduit 22 can include a vent 15. The used lubricating or hydraulic oil flows through the filter media and out of an outlet port 26 of the fine filtration canister 12. The fine filtration of the used lubricating or hydraulic oil helps remove any particulate contamination in the oil. The fine filtration can also remove any soft particles, including, but not limited to soft particles that are the result of agglomerated oxidation products. The useful life of the adsorption element 34 in the cellulose canister 14 and the silica bed 64 in the silica canister 16, as discussed below, can be increased by removing the soft particles from the oil upstream of the cellulose canister 14 and the silica canister 16. The used lubricating or hydraulic oil flows from the outlet port 26 of the fine filtration canister 12 into a hose conduit 28 that delivers the filtered used lubricating or hydraulic oil to an inlet port 32 of the cellulose canister 14.

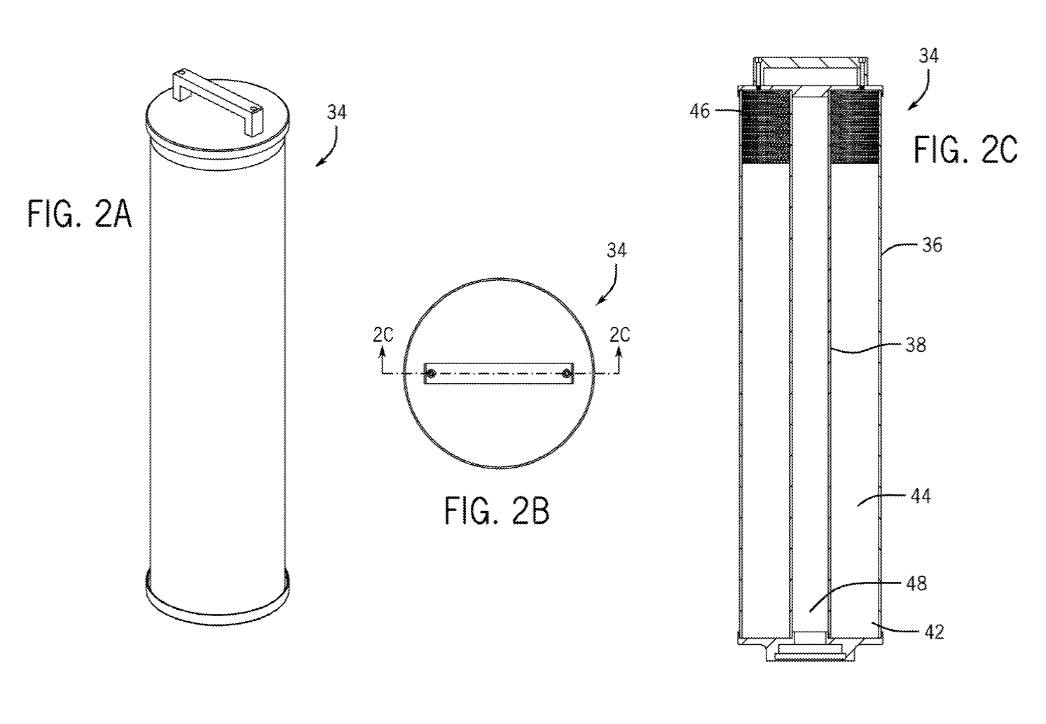

Looking at FIGS. 2A to 2C, there is shown one example embodiment of adsorption element 34 that is inserted in the cellulose canister 14 of the apparatus 10. The adsorption element 34 has a perforated cylindrical retainer 36 and a center core 38 that is perforated except for the top four inches of the core 38. The perforated cylindrical retainer 36 and the center core 38 define an annular space 42 of the adsorption element 34. A bed of shredded cellulose media 44 is arranged in the space 42. The shredded cellulose can be in configured in ribbons that are about 0.25 inches in width, however, other widths are contemplated as well. Note that the cellulose in this element 34 does not have to be shredded, it could instead be cut annular discs of cellulose media stacked with the center core 38 passing up through the center hole of the stack or any other structure, including, but not limited to a roll of cellulose media, pellets of cellulose, flat sheets, shredded sheets, or any other structure or configuration that exposes the used lubricating or hydraulic oil to high surface area cellulose. The polar nature and high surface area of the cellulose media 44 allows it to be used as a surface for adsorption of polar compounds from the used lubricating or hydraulic oil, which is non-polar in nature. It is also possible to combine the cellulose media 44 with the filter media in the fine filtration canister 12 by constructing the filter media to have cellulose fibers, or other structure, for either all or a portion of the filter media.

Foam 46 is arranged in the space 42 above the shredded cellulose media 44. The foam 46 is non-reticulated and helps to control the fluid path through the cellulose media 44. After the filtered used lubricating or hydraulic oil enters the inlet port 32 of the cellulose canister 14, the filtered used lubricating or hydraulic oil flows through the perforated cylindrical retainer 36, the shredded cellulose media 44, and the center core 38. After passing through the center core 38, the partially treated used lubricating or hydraulic oil exits through an oil outlet 48 and an outlet port 52 (see FIG. 1) of the cellulose canister 14 into a hose conduit 54 that delivers the partially treated used lubricating or hydraulic oil to an inlet port 56 of the silica canister 16.

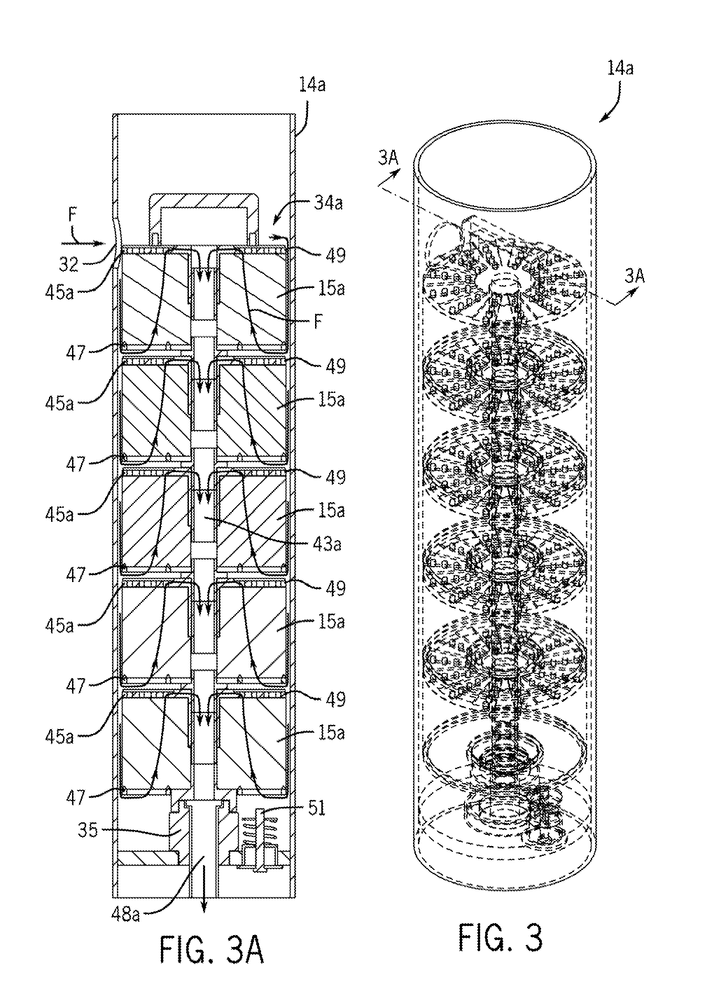

Referring now to FIGS. 3 and 3A, there is shown another example embodiment of a cellulose canister 14a for use in the apparatus 10 of FIG. 1. The cellulose canister 14a includes an adsorption element 34a having wound cellulose elements 15a and uses axial flow through the wound cellulose elements 15a that surround an axially arranged common outlet tube 43a. The adsorption element 34a can be coupled to the cellulose canister 14a with an adapter 35. The wound cellulose elements 15a include an exposed area 47 and perforated oil outlet gates 45a are arranged above each of the wound cellulose elements 15a in a disk 49. After the filtered used lubricating or hydraulic oil enters the inlet port 32 of the cellulose canister 14a, the filtered used lubricating or hydraulic oil flows through the wound cellulose elements 15a, the perforated oil outlet gates 45a, and into the common outlet tube 43a as shown in flow lines F of FIG. 3A. The further treated used lubricating or hydraulic oil can exit through an oil outlet 48a and outlet port 52 (see FIG. 1) of the cellulose canister 14a. The cellulose canister 14a can also include a bypass valve 51 measuring a differential pressure between the fluid pressure of the used lubricating or hydraulic oil prior to entering the adsorption element 34a and a pressure of the used lubricating or hydraulic oil external to the cellulose canister 14a. The bypass valve 51 can be set to a specified level, such as 50 PSID, such that if the differential fluid pressure is at the specified level or above, the used lubricating or hydraulic oil can bypass the adsorption element 34a, for example, by coupling to bypass conduit 82.

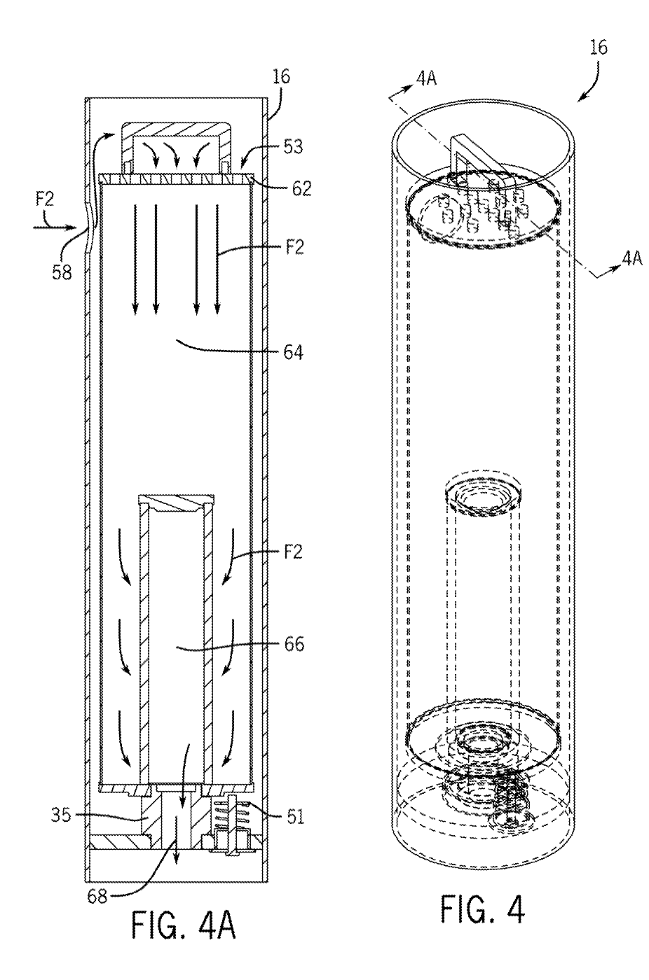

Looking at FIGS. 4 and 4A, there is shown one example embodiment of the silica canister 16 of the apparatus 10. The silica canister 16 can include a silica adsorption element 53 that is coupled to the silica canister 16 with an adapter 35. After the partially treated used lubricating or hydraulic oil enters the inlet port 56 of the silica canister 16, it passes through an oil inlet 58 and then through a perforated oil inlet gate 62 arranged above a silica bed 64. The partially treated used lubricating or hydraulic oil passes through the silica bed 64 and is further treated. Flow paths are shown by arrows F2 in FIG. 4A. The silica bed 64 can include silica gel. The silica gel can have a pore size of 30 microns or greater, more preferably 60 microns or greater, or even more preferably 120 microns or greater. It is contemplated that the pore size of the silica gel of the silica bed 64 can be of different pore sizes or of uniform pore size. The silica gel is polar, and therefore, efficient at attracting and removing polar materials in the used lubricating or hydraulic oil, which is non-polar. Due to its porous nature, the silica gel in the silica bed 64 has a high surface area, which further increases its effectiveness at removing the polar materials in the used lubricating or hydraulic oil. The porous nature of the silica gel in the silica bed 64 provides an adsorbent of higher surface area per unit mass than a similar non-porous particle, or even a smaller non-porous particle.

The partially treated used lubricating or hydraulic oil then passes into a high pressure filter element 66 (which may be separated from the silica bed 64 by a screen) and then into an oil outlet 68 and outlet port 72 (see FIG. 1) of the silica canister 16. The high pressure filter element 66 can have filter media having a pore size of 1 micron. The silica canister 16 can also include a bypass valve 51 that can be set to a specified level, such as 50 PSID, and can function similarly to the bypass valve 51 of the cellulose canister 14a described above.

The treated lubricating or hydraulic oil flows from the outlet port 72 of the silica canister 16 into a hose conduit 73 that delivers the treated used lubricating or hydraulic oil to an outlet filter 74. The outlet filter 74 can be of a pore size of about 3 microns. From the outlet filter 74, the treated lubricating or hydraulic oil flows through a valve 23 into an oil outlet 84. The oil outlet 84 can be coupled to a reservoir (not shown) for collecting the treated lubricating or hydraulic oil or it may be coupled to equipment where the treated lubricating or hydraulic oil can be put back in use.

Each of the filtration canister 12, the cellulose canister 14, and the silica canister 16 include a drain 13 near the bottom of the canisters 12, 14, 16 and a vent 15 near the top of the canisters 12, 14, 16. Each canister can also include one or more valves 23 connected in ports. Each canister 12, 14, 16 can also include at least one pressure gauge 17 for monitoring the pressure at each stage of the apparatus 10. A pressure gauge 17 can also be placed on the outlet filter 74. The apparatus 10 can also include a backpressure switch 19 located along hose conduit 73. The backpressure switch 19 can be in electrical communication with a control panel 21. The backpressure switch 19 can be set at a specified pressure, including, but not limited to, 35 psig. The control panel 21 can be configured such that if a pressure reading is above the specified pressure, the control panel 21 can disengage the pump 20.

The apparatus 10 can also have a bypass system 80, which includes a bypass hose conduit 82 that is coupled to hose conduit 22 upstream of the inlet port 24 on the filtration canister 12 on one end and coupled to an oil return conduit 84 downstream of the outlet filter 74 on an opposite end. In one configuration, the bypass system 80 can be activated as an alternative to disengaging the pump 20 when the bypass valves 51 are opened in the cellulose canister 14, 14a and/or the silica canister 16 as described above. Alternatively or additionally, the bypass system 180 can be configured to activate upon a pressure reading being above a specified pressure and can direct the flow of the used lubricating or hydraulic oil through the bypass hose conduit 82 rather than through the canisters 12, 14, 16.

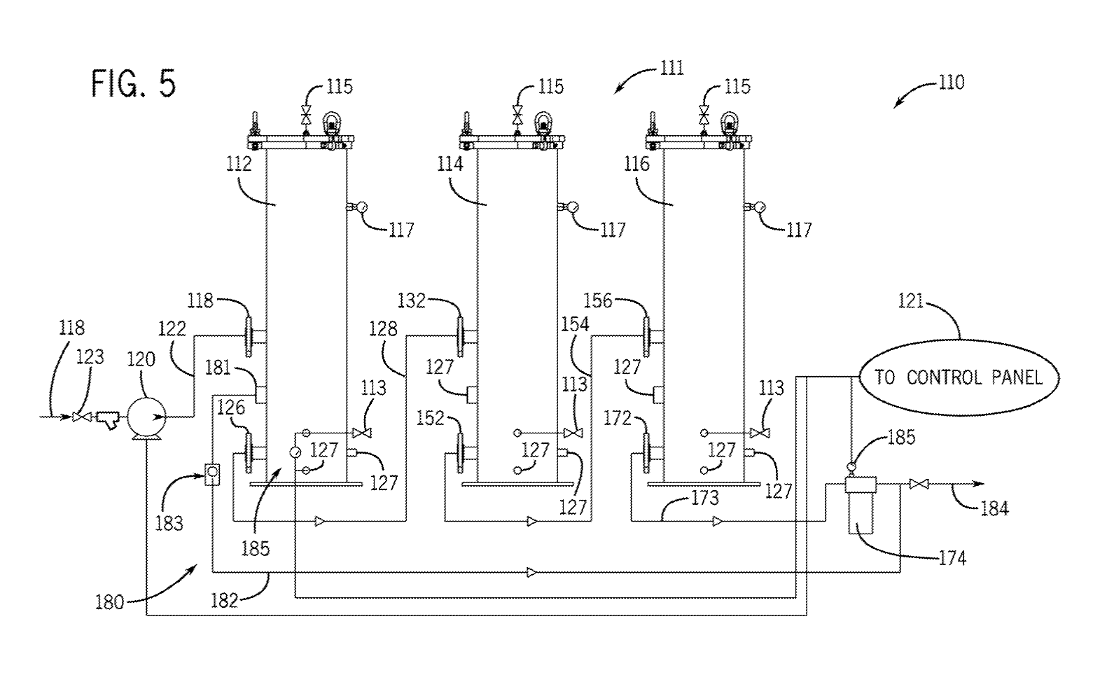

Referring now to FIG. 5, another embodiment of an apparatus 110 for removing contaminants from used lubricating or hydraulic oil is illustrated. The apparatus 110 can include a fluid transfer unit 111. The apparatus 110 includes a filtration canister 112 providing fine filtration, a cellulose canister 114, and a silica canister 116. Similar to the apparatus 10 described above, used lubricating or hydraulic oil is fed from a source (not shown) of used lubricating or hydraulic oil through an oil inlet 118 and valve 123 by a gear pump 120. The gear pump 120 can move the used lubricating or hydraulic oil through a hose conduit 122 to an inlet port 118 of the filtration canister 112. The filtration canister 112 can include microfiber filter media providing fine filtration, e.g., a pore size of 1 micron, such as Porous Media's STRATAFORM® microfiber media that are used in GENESIS® coreless filter elements, which features a stratified media matrix resulting in an increasing tapered pore structure, with the largest pores on the upstream side of the media. The used lubricating or hydraulic oil flows through the filtration canister 112 and out of an outlet port 126. The filtration canister 112 can provide the same benefits and advantages as discussed above with respect to the filtration canister 12. The used lubricating or hydraulic oil flows from the outlet port 126 into a hose conduit 128 that delivers the filtered used lubricating or hydraulic oil to an inlet port 132 of the cellulose canister 114.

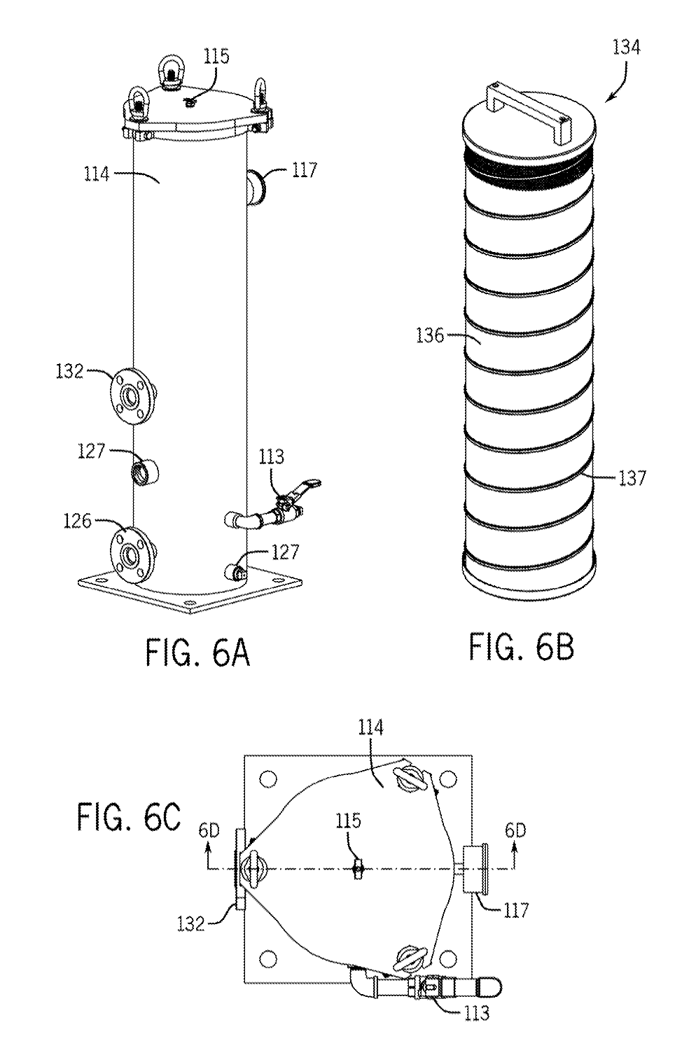

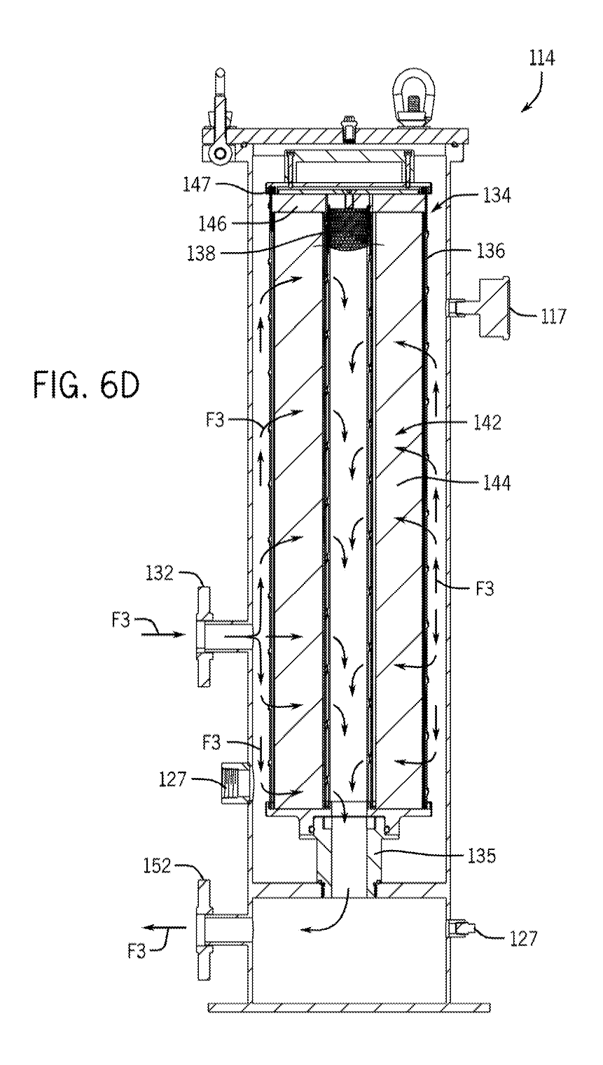

FIGS. 6A-6D illustrate an exemplary embodiment of a cellulose canister 114 and adsorption element 134 that can be used in the cellulose canister 114. As shown in FIGS. 6B and 6D, the adsorption element 134 has a perforated cylindrical retainer 136 and a perforated center core 138. Only a top portion of the cylindrical retainer 136 and the center core 138 are shown as perforated for drawing simplicity purposes, however, in this embodiment, the perforations are carried throughout the length of the retainer 136 and the length of the center core 138. The perforated cylindrical retainer 136 can also include a spiral ribbing 137 on an exterior of the retainer 136.

As shown in FIG. 6D, the adsorption element 134 is inserted into the cellulose canister 114 and coupled to the cellulose canister 114 with an adapter 135. The perforated cylindrical retainer 136 and the perforated center core 138 define an annular interior space 142 of the adsorption element 134. Cellulose media 144 can be placed in the interior space 142 of the adsorption element 134. In the embodiment illustrated in FIG. 6D, the cellulose media 144 is in the form of several hundred annular discs compressed tightly in a stacked fashion. For drawing simplicity purposes, the annular discs of cellulose media 144 are illustrated as a single unit. When loosely placed in the interior space 142, the annular discs of cellulose media 144 can be approximately 0.040 inches in thickness, however, when compressed, the annular discs of cellulose media 144 can be approximately 0.025 inches in thickness. Of course, the number and thicknesses of annular discs can be varied, in both the loose and compressed configurations, to a dimension in the range including, but not limited to, approximately 0.010 inches to approximately 0.750 inches. Furthermore, the cellulose media 144 can alternatively or additionally be shredded, or can be in any form that exposes the used lubricating or hydraulic oil to the cellulose, including, but not limited to, a roll of cellulose media, pellets of cellulose flat or shredded sheets of cellulose, or loosely configured cellulose. The cellulose media 144 can provide the same advantages and benefits to treating the used lubricating or hydraulic oil as discussed above with respect to the cellulose media 44 in apparatus 10. Foam 146 and a compression disk 147 can be arranged above the cellulose media 144.

The flow of the used lubricating or hydraulic oil in the cellulose canister 114 flows in through the inlet port 132, through the perforated cylindrical retainer 136, the shredded cellulose media 144, and the perforated center core 138, and out to an oil outlet 148 and outlet port 152. The fluid path is shown by arrows F3 in FIG. 6D. The used lubricating or hydraulic oil flows from the outlet port 152 through a hose conduit 154 to deliver the partially treated used or lubricating hydraulic oil to the inlet port 156 of the silica canister 116.

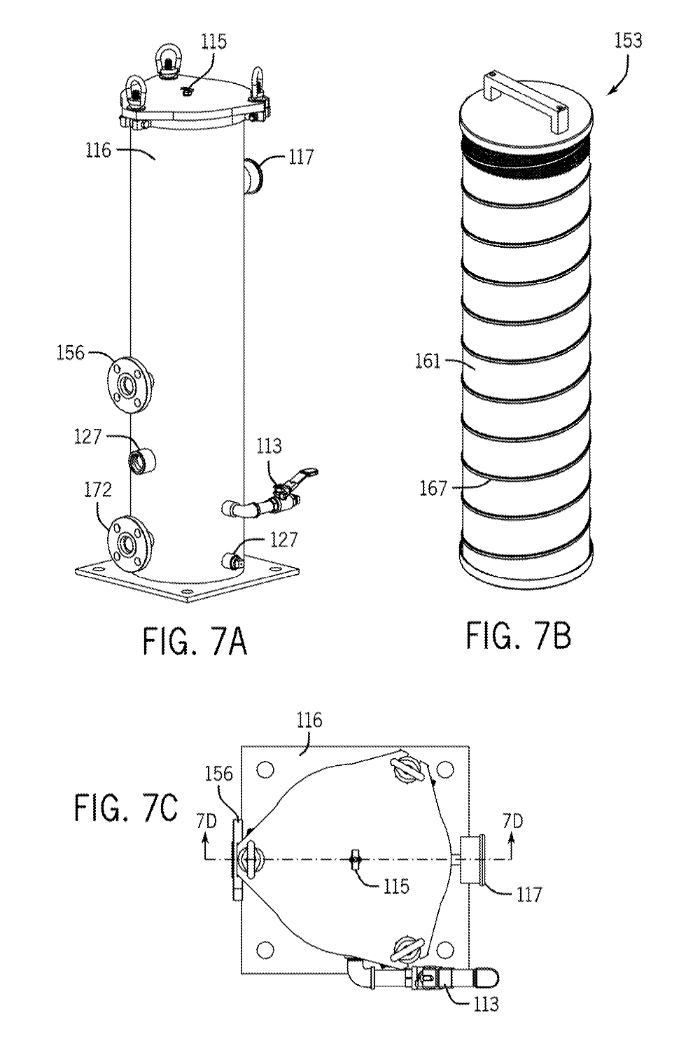

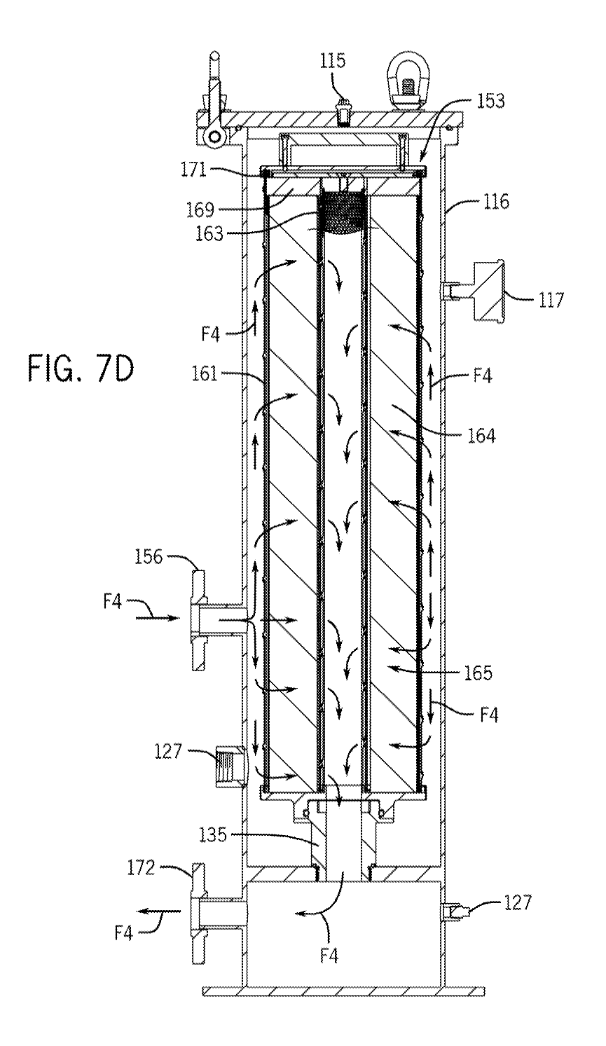

Referring now to FIGS. 7A-7D, an exemplary embodiment of a silica canister 116 and silica adsorption element 153 that can be used in the silica canister 116 are shown. As shown in FIGS. 7B and 7D, the silica adsorption element 153 is configured similarly to the adsorption element 134 of FIGS. 6B and 6D. As shown in FIGS. 7B and 7D, the silica adsorption element 153 has a perforated cylindrical retainer 161 and a perforated center core 163. Only a top portion of the cylindrical retainer 161 and the center core 163 are shown as perforated for drawing simplicity purposes, however, in this embodiment, the perforations are carried throughout the length of the retainer 161 and center core 163. The perforated cylindrical retainer 161 can also include a spiral ribbing 167 on an exterior of the retainer 161. An interior surface of the perforated cylindrical retainer 161 is lined with wire cloth. The perforated center core 163 can be wrapped in wire cloth.

As shown in FIG. 7D, the silica adsorption element 153 is inserted into the silica canister 116 and coupled to the canister with an adapter 135. The perforated cylindrical retainer 161 and the perforated center core 163 define an annular interior space 165 of the adsorption element 153. A silica bed 164 can be placed in the interior space 165 of the adsorption element 153. The silica bed 164 can be configured as silica gel of the same properties and sizes and can provide the same benefits and advantages for treating the partially treated used lubricating or hydraulic oil as discussed above with respect to the silica gel of silica bed 64 in apparatus 10. Foam 169 and a compression disk 171 can be arranged above the silica bed 164.

The used lubricating or hydraulic oil flows through the silica canister 116 by entering the inlet port 156, flowing through the perforated cylindrical retainer 161, the silica bed 164, the perforated center core 163. When passing through the silica bed 164, the used lubricating or hydraulic oil is further treated. After passing through the perforated center core 163, the used lubricating or hydraulic oil flows to an outlet port 172 of the silica canister 116 and into a conduit 173. The fluid path of the used lubricating or hydraulic oil in the silica canister 116 is shown with arrows F4 in FIG. 6D. The conduit 173 delivers the treated used lubricating or hydraulic oil to an outlet filter 174. The outlet filter 174 can be of a pore size of about 3 microns.

As shown in FIG. 5, the filtration canister 112, the cellulose canister 114, and the silica canister 116 each include a drain 113 near the bottom of the canisters 112, 114, 116 and a vent 115 near the top of the canisters 112, 114, 116. Each canister 112, 114, 116 can also include at least one pressure gauge 117 for monitoring the pressure at each stage of filtering and treating the used lubricating or hydraulic oil in the apparatus 110. Other ports can be provided on the canisters 112, 114, 116 for various purposes, including, but not limited to, taking pressures at other locations. While not being used, these ports can be closed with plugs 127.

The apparatus 110 can also have a bypass system 180. The bypass system 180 can include a bypass hose conduit 182 that is coupled to bypass port 181 on the filter canister 112 on one end and coupled to an oil return conduit 184 downstream of the outlet filter 174 on an opposite end. A pressure relief valve 183 can be placed in the bypass hose conduit 182. The pressure relief valve 183 can include a spring that is configured to open if the pressure in the used lubricating or hydraulic oil that is pumped into the filter canister 112, but has yet to pass through the filter media, is above a specified pressure, e.g., 75 PSI. If the pressure relief valve 183 opens, the used lubricating or hydraulic oil can exit the filter canister 112 through the bypass port 181 and through the bypass hose conduit 182. For example, if the filter media in the filter canister 112 is becoming filled, the pressure of the lubricating or hydraulic oil upstream of the filter media in the filter canister 112 may be above the specified pressure of the pressure relief valve 183, such that the pressure relief valve will open and allow the used lubricating or hydraulic oil to bypass the filter media in the filter canister 112 as well as bypass the cellulose and silica canisters 114, 116.

The apparatus 110 can also include one or more differential pressure switches 185 that are in electrical communication with a control panel 121. One differential pressure switch 185 can be configured with the filter canister 112 to measure the pressure differential of the used lubricating or hydraulic oil upstream of the filter media and downstream of the filter media. Another differential pressure switch 185 can be configured with the outlet filter 174 to measure the pressure differential between used lubricating or hydraulic oil upstream and downstream of the outlet filter 174. The differential pressure switches 185 and the control panel 121 can be configured to disengage the pump 120 if one or more of the switches 185 measure a pressure differential above a specified level, e.g., 30 PSID, because the pump 120 is in electrical communication with the control panel 121. Alternatively or additionally, the differential pressure switches 185 and the control panel 121 can provide a notification, such as a textual, symbolic, and/or audible notification, if one or more of the switches 185 measure a pressure differential above the specified level or a pressure differential that is approaching the specified level.

Different mass ratios of the silica gel in the silica bed 64, 164 to the cellulose media 44, 144 can be used in the apparatuses 10, 110. For example, in a preferred embodiment, the mass ratio of silica gel to cellulose is about 3.5 to 1. It is contemplated, however, that other mass ratios in the range of 0.25 to 1 to 10 to 1, including, but not limited to, 1.5 to 1, can be used in the apparatuses 10, 110.

The combination of the silica bed 64, 164 and the cellulose media 44, 144 provide synergistic results for removing oxidation products of the used lubricating or hydraulic oil beyond the results expected by using either the silica bed 64, 164 or cellulose media 44, 144 alone. It is suspected that the combination provides such results because the cellulose in the cellulose media 44, 144 captures large polar molecules of the used oil that would be too large to penetrate the pores of the silica gel in the silica bed 64, 164, while the silica gel has a higher surface area per unit mass is more efficient at capturing the smaller polar molecules the used oil. For this reason, it is preferable to place the cellulose media 44, 144 upstream of the silica bed 64, 164 as shown in the embodiments illustrated in FIGS. 1 and 5. However, an apparatus configured to have the silica bed 64, 164 placed upstream of the cellulose media 44, 144 while it may be less desirable, is also contemplated. This theory for the synergistic results is merely proposed, and is not intended to limit the embodiments or invention in any fashion.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for the use of the ordinal term) to distinguish the claim elements.

Although the present invention has been described in detail with reference to certain embodiments, one skilled in the art will appreciate that the present invention can be practiced by other than the described embodiments, which have been presented for purposes of illustration and not of limitation. For example, it is contemplated that an embodiment can be configured in which the silica gel of the silica bed 64, 164 and the cellulose media 44, 144 are combined into one canister. Additionally, it is also contemplated that an apparatus can be configured in which the silica gel of the silica bed 64, 164, the cellulose media 44, 144, and the fine filtration media of the filtration canister 12, 112 can all be combined in one canister. Therefore, the scope of the appended claims should not be limited to the description of the embodiments contained herein.

1. An apparatus for removing contaminants from used lubricating or hydraulic oil, the apparatus comprising:
a fluid transfer unit including an inlet port and an outlet port, the inlet port being in fluid communication with a source of the used lubricating or hydraulic oil, the fluid transfer unit defining a fluid path;
a first adsorbent in the fluid path, the first adsorbent including cellulose; and
a second adsorbent in the fluid path, the second adsorbent including silica gel.

2. The apparatus of claim 1, wherein the fluid path is configured such that the first adsorbent is upstream of the second adsorbent.

3. The apparatus of claim 1, wherein the fluid path is configured such that the second adsorbent is upstream of the first adsorbent.

4. The apparatus of claim 1, wherein the first adsorbent and the second adsorbent are in a mixed form.

5. The apparatus of claim 1, wherein the fluid transfer unit further includes a filter, the filter being upstream of the first adsorbent and the second adsorbent.

6. The apparatus of claim 5, wherein the filter includes filter media of no larger than about 1 micron.

7. The apparatus of claim 5, wherein the filter includes cellulose.

8. The apparatus of claim 1, wherein the cellulose is in a form of one of fibers, particles, pellets, sheets, discs, or mixtures thereof.

9. The apparatus of claim 1, wherein the silica gel is constructed to have an average pore size of about 30 microns or greater.

10. The apparatus of claim 1, wherein the silica gel is constructed to have an average pore size of about 120 microns or greater.

11. The apparatus of claim 1, wherein a mass ratio of the silica gel to the cellulose is about 0.5 to 1 to about 5 to 1.

12. The apparatus of claim 1, further comprising a bypass system including a bypass conduit and a pressure relief valve positioned in the bypass conduit, the bypass system configured to selectively allow the used lubricating or hydraulic oil to bypass the first adsorbent and the second adsorbent.

13. The apparatus of claim 1, further comprising:
a control panel;
a pump moving used lubricating or hydraulic oil through the fluid transfer unit, the pump in electrical communication with the control panel; and
at least one pressure differential switch configured to measure pressure differential in the fluid path, the at least one pressure differential switch being in electrical communication with the control panel;
wherein the control panel is configured to disengage the pump upon the at least one pressure differential switch measuring a pressure differential above a specified level.

14. A method of removing contaminants from used lubricating or hydraulic oil, the method including:
providing a source of used lubricating or hydraulic oil;
providing an apparatus including a fluid transfer unit, the fluid transfer unit including an inlet and an outlet, the fluid transfer unit in fluid communication with the source of the used lubricating or hydraulic oil and the fluid transfer unit defining a fluid path;
providing a first adsorbent and a second adsorbent in the fluid path, the first adsorbent including cellulose, the second adsorbent including silica gel; and
moving the used lubricating or hydraulic oil from the source of the used lubricating or hydraulic oil to the apparatus such that the fluid path of the used lubricating or hydraulic oil contacts the first adsorbent and the second adsorbent to remove contaminants from the used lubricating or hydraulic oil.

15. The method of claim 14, wherein the fluid path is configured such that first adsorbent is upstream of the second adsorbent.

16. The method of claim 14, wherein the fluid path is configured such that the second adsorbent is upstream of the first adsorbent.

17. The method of claim 14, further comprising:
providing a filter in the fluid path; and
filtering the used lubricating or hydraulic oil with the filter;
wherein the fluid path is configured such that the filter is upstream of the first adsorbent and the second adsorbent.

18. The method of claim 14, wherein the contaminants are polar.

19. The method of claim 14, further including:
providing a control panel;
providing a pump configured to move the used lubricating or hydraulic oil from the source of the used lubricating or hydraulic oil to the apparatus, the pump being in electrical communication with the control panel;
coupling at least one pressure differential switch at a point along the fluid path to measure pressure differential, the at least one pressure differential switch being in electrical communication with the control panel; and
configuring the control panel to disengage the pump upon the at least one pressure differential switch measuring a pressure differential above a specified level.

20. An apparatus for removing contaminants from used lubricating or hydraulic oil, the apparatus comprising:
a fluid transfer unit including a first housing and a second housing, the first housing defining a first interior space and including a first inlet port and a first outlet port, the second housing defining a second interior space and including a second inlet port and a second outlet port, the fluid transfer unit defining a fluid path wherein the first housing is in fluid communication with the second housing;
a first adsorbent in the fluid path, the first adsorbent including cellulose; and
a second adsorbent in the fluid path, the second adsorbent including silica gel.

21. The apparatus of claim 20, wherein the first adsorbent is within the first interior space and the second adsorbent is within the second interior space.

22. The apparatus of claim 21, wherein the first housing is upstream of the second housing.

23. The apparatus of claim 21, wherein the first housing is downstream of the second housing.

24. The apparatus of claim 21, wherein the first housing includes a first perforated retainer and a first core, the first adsorbent being between the first perforated retainer and the first core, the fluid path configured such that the used lubricating or hydraulic oil flows through the first inlet port, the first perforated retainer, the first adsorbent, and the first core to the first outlet port.

25. The apparatus of claim 24, wherein the second housing includes a second perforated retainer and a second core, the second adsorbent being between the second perforated retainer and the second core, the fluid path configured such that the used lubricating or hydraulic oil flows through the second inlet, the second perforated retainer, the second adsorbent, and the second core to the second outlet.

26. The apparatus of claim 25, wherein the second perforated retainer and the second cylindrical core are each lined with wire cloth.

27. The apparatus of claim 20, the fluid transfer unit further comprising an inlet filter, the inlet filter being upstream of the first housing and the second housing.

28. The apparatus of claim 20, the fluid transfer unit further comprising an outlet filter, the outlet filter being downstream of the first housing and the second housing.

29. The apparatus of claim 20, further comprising a conduit coupled on a first end to the first outlet port of the first housing and coupled on a second end to the second inlet port of the second housing.

30. The apparatus of claim 20, further comprising:
a pump configured to pump used lubricating or hydraulic oil from a source of used lubricating or hydraulic oil through the fluid transfer unit through the fluid path; and
a bypass system including a bypass conduit and a pressure relief valve positioned in the bypass conduit, the bypass system configured to selectively allow the used lubricating or hydraulic oil to bypass the first housing and the second housing of the fluid transfer unit.

31. The apparatus of claim 20, further comprising:
a control panel;
a pump moving used lubricating or hydraulic oil through the fluid transfer unit, the pump in electrical communication with the control panel; and
at least one pressure differential switch configured to measure pressure differential in the fluid path, the at least one pressure differential switch being in electrical communication with the control panel;
wherein the control panel is configured to disengage the pump upon the at least one pressure differential switch measuring a pressure differential above a specified level.
